(19) United States
(12) Patent Application Publication
(10) Pub. No.: US 2026/0105286 A1
(43) Pub. Date: Apr. 16, 2026

(54) MODEL LEARNING DEVICE, NON-TRANSITORY COMPUTER-READABLE MEDIUM, AND MODEL LEARNING METHOD

(71) Applicant: NEC Corporation, Tokyo (JP)

(72) Inventors: Yoichi ISHIBASHI, Tokyo (JP); Taro YANO, Tokyo (JP); Masafumi OYAMADA, Tokyo (JP)

(73) Assignee: NEC Corporation, Tokyo (JP)

(21) Appl. No.: 19/346,830

(22) Filed: Oct. 1, 2025

(30) Foreign Application Priority Data
Oct. 11, 2024 (JP) 2024-179341

(51) Int. Cl. G06N 3/0475; G06N 3/045; G06N 3/08

(52) U.S. Cl. CPC G06N 3/0475; G06N 3/045; G06N 3/08

(57) ABSTRACT

A model learning device includes an acquisition unit for acquiring a second generative model constructed to output a draft of a method for constructing a first generative model for generating information, and an evaluation result indicating evaluation made on the draft output by the second generative model, and a learning processing unit for, when the second generative model and the evaluation result are input, generating a new second generative model in which a draft output algorithm is changed, by causing the second generative model to post-learn based on the evaluation result.The model training device employs AI and machine learning techniques to optimize decision making processes in generative model construction.

### INCORPORATION BY REFERENCE

This application is based upon and claims the benefit of priority from Japanese patent application No. 2024-179341, filed on October 11, 2024, the disclosure of which is incorporated herein in its entirety by reference.

### TECHNICAL FIELD

The present disclosure relates to a model learning device, a non-transitory computer-readable medium, and a model learning method.

### BACKGROUND ART

Conventionally, various techniques related to post-learning of a generative model have been proposed. Weizhe Yuan, “Self-Rewarding Language Models” (ICML2024, January 18, 2024) discloses that an n-th generation large-scale language model (hereinafter, the target model) generates text data useful for improving itself, that a target model generates learning data by evaluating quality of text data itself, and that a target model generates an (n+1)-th generation target model by learning itself by using the learning data. Chris Lu, “Discovering Preference Optimization Algorithms with and for Large Language Models” (arXiv, June 12, 2024) discloses that an n-th generation large-scale language model (draft generative model) generates a draft (how to make a model) useful for improving a target model, and that the target model generates an (n+1)-th generation target model by reconstructing itself using the draft.

### SUMMARY

Since the technique disclosed in Weizhe Yuan, “Self-Rewarding Language Models” (ICML2024, January 18, 2024) focuses on generating learning data, the quality of the learning data can be improved. However, sufficient performance improvement of the target model cannot be expected only by improving the quality of the learning data. In the technique disclosed in Chris Lu, “Discovering Preference Optimization Algorithms with and for Large Language Models” (arXiv, June 12, 2024), since the target model is recreated by the algorithm generated by the draft generative model, there is a possibility that the performance is improved as compared with the case of improving the target model using the learning data. However, the draft generative model does not necessarily generate a draft suitable for improving the performance of the target model. That is, it is difficult for the technique disclosed in Chris Lu, “Discovering Preference Optimization Algorithms with and for Large Language Models” (arXiv, June 12, 2024) to efficiently improve the performance of the target model.

The present disclosure has been made in view of the above problems, and an example object of the present disclosure is to more efficiently improve the performance of a generative model in a method of improving the performance of the generative model by modifying a target generative model based on a draft of a modification method.

A model learning device according to an example aspect of the present disclosure includes an acquisition means for acquiring a second generative model constructed to output a draft of a method for constructing a first generative model for generating information, and an evaluation result indicating evaluation made on the draft output by the second generative model, and a learning processing means for, when the second generative model and the evaluation result are input, generating a new second generative model in which a draft output algorithm is changed, by causing the second generative model to post-learn based on the evaluation result.

A model learning program according to an example aspect of the present disclosure causes a computer to execute acquisition processing of acquiring a second generative model constructed to output a draft of a method for constructing a first generative model for generating information, and an evaluation result indicating evaluation made on the draft output by the second generative model, and learning processing of causing, when the second generative model and the evaluation result are input, the second generative model to post-learn based on the evaluation result and generating a new second generative model in which a draft output algorithm is improved.

A model learning method according to an example aspect of the present disclosure includes an acquisition step in which a computer acquires a second generative model constructed to output a draft of a method for constructing a first generative model for generating information, and an evaluation result indicating evaluation made on the draft output by the second generative model, and a learning processing step in which the computer causes, when the second generative model and the evaluation result are input, the second generative model to post-learn based on the evaluation result and generating a new second generative model in which a draft output algorithm is improved.

According to an illustrative aspect of the present disclosure, the performance of the generative model can be more efficiently improved.

### BRIEF DESCRIPTION OF DRAWINGS

FIG. 1 is a block diagram illustrating an example of a functional configuration of a model learning device according to a first illustrative example embodiment of the present disclosure;

FIG. 2 is a flowchart illustrating an example of a flow of a model learning method according to the first illustrative example embodiment of the present disclosure;

FIG. 3 is a block diagram illustrating an example of a functional configuration of a model learning device according to a second illustrative example embodiment of the present disclosure;

FIG. 4 is a flowchart illustrating an example of a flow of a model learning method according to the second illustrative example embodiment of the present disclosure;

FIG. 5 is a block diagram illustrating an example of a functional configuration of a model learning device according to a third illustrative example embodiment of the present disclosure;

FIG. 6 is a diagram for explaining how to use a model learning device according to the third illustrative example embodiment of the present disclosure;

FIG. 7 is a diagram for explaining effects provided by a model learning device according to the third illustrative example embodiment;

FIG. 8 is a flowchart illustrating an example of a flow of a model learning method according to the third illustrative example embodiment of the present disclosure; and

FIG. 9 is a block diagram illustrating a hardware configuration of a computer that functions as the model learning device according to the present disclosure.

### EXAMPLE EMBODIMENT

Hereinafter, example embodiments of the present invention will be exemplified. However, the present invention is not limited to the illustrative example embodiments described below, and various modifications can be made within the scope described in the claims. For example, example embodiments obtained by appropriately combining technical means adopted in the following illustrative example embodiments can also be included in the scope of the present invention. Example embodiments obtained by appropriately omitting some of the technical means adopted in the following illustrative example embodiments can also be included in the scope of the present invention. Effects mentioned in the following illustrative example embodiments are examples of effects expected in the illustrative example embodiments, and do not define the extension of the present invention. In other words, example embodiments that do not provide the effects mentioned in the following illustrative example embodiments can also be included in the scope of the present invention.

### [First illustrative example embodiment]

First, a first illustrative example embodiment that is an example of the example embodiments of the present invention will be described in detail with reference to the drawings. The present illustrative example embodiment is a basic form of each illustrative example embodiment to be described below. An application scope of each technical means adopted in the present illustrative example embodiment is not limited to the present illustrative example embodiment. That is, each technical means adopted in the present illustrative example embodiment can also be adopted in other illustrative example embodiments included in the present disclosure as long as no particular technical problem occurs. Each technical means illustrated in the drawings referred to for describing the present illustrative example embodiment can also be adopted in other illustrative example embodiments included in the present disclosure as long as no particular technical problem occurs.

### (Generative model)

Prior to description of the model learning device 1, a generative model related to the model learning device 1 will be described. The generative models related to the model learning device 1 include a first generative model M1 and a second generative model M2.

### First generative model M1

The first generative model M1 is constructed to generate information according to an input. The “information” includes text, images, moving images, and the like. That is, the first generative model M1 may be a large-scale language model (LLM) that generates text. The first generative model M1 may be an image generative model that generates an image. The image generated by the image generative model may be a moving image or a still image. The “information” may include an identification result. That is, the first generative model M1 may be an image identification model or the like. The first generative model M1 may be a multimodal model in which different types of trained models are combined.

### Second generative model M2

The second generative model M2 is a generative model to be improved by the model learning device 1 according to the present example embodiment. The second generative model M2 is constructed to output the draft when a prompt for instructing to output the draft is input. The “draft” is a draft of a method for constructing the first generative model M1.

### Configuration of model learning device 1

Next, a configuration of the model learning device 1 will be described with reference to FIG. 1. FIG. 1 is a block diagram illustrating a configuration of a model learning device 1. As illustrated in FIG. 1, the model learning device 1 includes an acquisition means 11 and a learning processing means 12.

### Acquisition means 11

The acquisition means 11 acquires a second generative model (n-th generation: n=1, 2, ...) and an evaluation result indicating evaluation made on the draft output by the second generative model (n-th generation). The acquisition means 11 may be configured to acquire an evaluation result generated by the model learning device 1 or may be configured to acquire an evaluation result generated by another device different from the model learning device 1.

### Learning processing means 12

When the second generative model M2 and the evaluation result are input, the learning processing means 12 generates a new second generative model ((n+1)-th generation) by post-learning the second generative model (n-th generation) based on the evaluation result. The “second generative model ((n+1)-th generation)” is a generative model in which a draft output algorithm (weight or the like in the model) is changed from the second generative model (n-th generation).

### Model learning device 1 and others

The model learning device 1 may be configured to output the second generative model ((n+1)-th generation) generated by the learning processing means 12 to the outside, or may be configured to be used for processing in the model learning device 1.

### Effects of model learning device 1

In the model learning device 1 described above, a configuration is adopted in which the learning processing means 12 causes the second generative model (n-th generation) to post-learn based on the evaluation result to generate the second generative model ((n+1)-th generation) in which the draft output algorithm is changed. That is, the model learning device 1 improves the content of the draft of the method for constructing the first generative model (n-th generation) by causing the second generative model (n-th generation) to perform post-learning. Therefore, according to the model learning device 1 according to the present example embodiment, the performance of the first generative model M1 can be more efficiently improved.

### Flow of model learning method S1

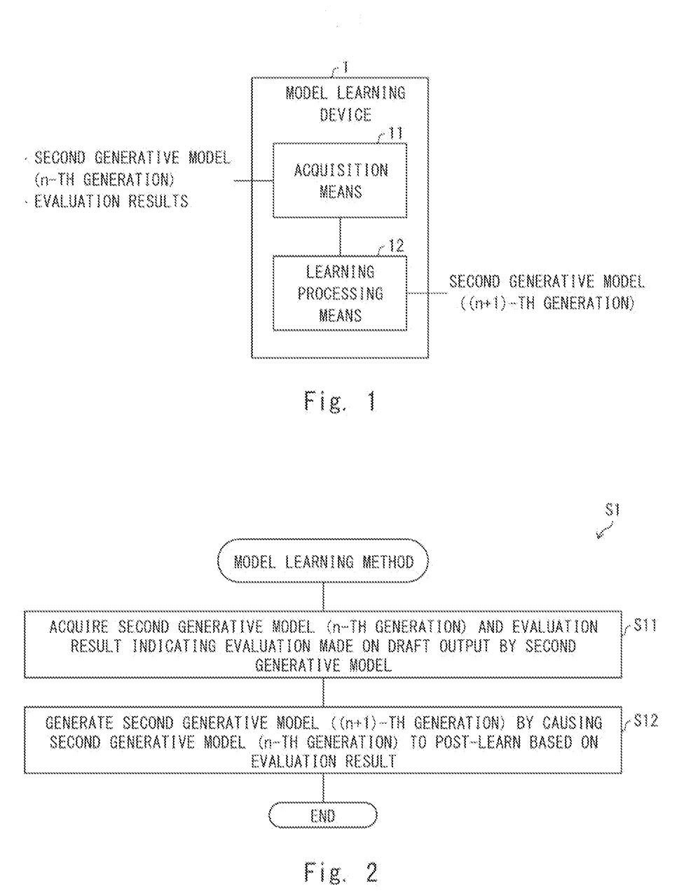

Next, a flow of the model learning method S1 will be described with reference to FIG. 2. FIG. 2 is a flowchart illustrating a flow of the model learning method S1. As illustrated in FIG. 2, the model learning method S1 includes an acquisition step S11 and a learning processing step S12.

### Acquisition step S11

In the first acquisition step S11, the computer acquires the second generative model (n-th generation) and the evaluation result indicating the evaluation made on the draft output by the second generative model (n-th generation). In the acquisition step S11, the computer may acquire an evaluation result generated by itself or may acquire an evaluation result generated by another device different from itself. In acquisition step S11, an evaluation result input to the computer by a human may be acquired.

### Learning processing step

After the second generative model (n-th generation) and the evaluation result are acquired, the process proceeds to learning processing step S12. In the learning processing step S12, the computer causes post-learning of the second generative model (n-th generation) based on the evaluation result to generate the second generative model ((n+1)-th generation).

### Model learning method S1 and others

In the model learning method S1, the second generative model ((n+1)-th generation) generated by the computer may be output to the outside or used for processing in the computer.

### Effects of model learning method S1

As described above, in the model learning method S1, in the learning processing step S12, a configuration is adopted in which the second generative model (n-th generation) is subjected to post-learning based on the evaluation result to generate the second generative model ((n+1)-th generation) in which the draft output algorithm is changed. That is, in the model learning method S1, the content of the draft of the method for constructing the first generative model (n-th generation) is improved by performing post-learning on the second generative model (n-th generation). Therefore, according to the model learning method S1 according to the present example embodiment, the performance of the first generative model M1 can be more efficiently improved.

### Second illustrative example embodiment

Next, a second illustrative example embodiment that is an example of the example embodiments of the present invention will be described in detail with reference to the drawings. Components having the same functions as the components described in the above-described illustrative example embodiment will be denoted by the same reference numerals, and the description thereof will be appropriately omitted. An application scope of each technical means adopted in the present illustrative example embodiment is not limited to the present illustrative example embodiment. That is, each technical means adopted in the present illustrative example embodiment can also be adopted in other illustrative example embodiments included in the present disclosure as long as no particular technical problem occurs. Each technical means illustrated in each of the drawings referred to for describing the present illustrative example embodiment can be adopted in other illustrative example embodiments included in the present disclosure as long as no particular technical problem occurs.

### (Generative model)

Prior to description of the model learning device 1A, a generative model related to the model learning device 1A will be described. The generative models related to the model learning device 1A include a first generative model M1 and a second generative model M2A.

### - First generative model M1

The first generative model M1A is a generative model to be improved by the model learning device 1A according to the present example embodiment. The first generative model M1A according to the present example embodiment may be configured by one trained model, a plurality of trained models of the same type, or a multimodal model in which different types of trained models are combined.

### - Second generative model M2

The second generative model M2A is also a generative model to be improved by the model learning device 1A according to the present example embodiment. Similarly to the second generative model M2 according to the first illustrative example embodiment, the second generative model M2A according to the present example embodiment is constructed to output a draft when a prompt (For example, “output a merge function that synthesizes three LLMs”, and the like.) is input. The method for constructing the first generative model M1A indicated by the “draft” generated by the second generative model M2A according to the present example embodiment is model merging. “Model merging” is a method of constructing a new generative model by synthesizing weight parameters of a plurality of generative models. By using model merging, a new generative model can be constructed without learning. The method of constructing the first generative model M1A may be a communication protocol or a text game.

### (Configuration of model learning device 1)

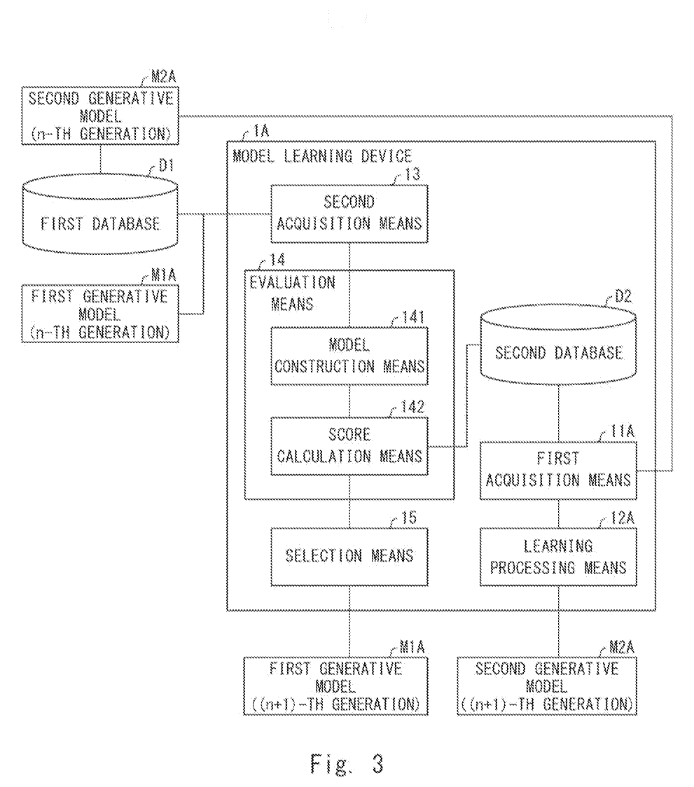

First, a configuration of the model learning device 1A will be described with reference to FIG. 3. FIG. 3 is a block diagram illustrating a configuration of the model learning device 1A. As illustrated in FIG. 3, the model learning device 1A according to the present example embodiment includes a first acquisition means 11A (acquisition means), a learning processing means 12A, a second acquisition means 13, an evaluation means 14, a selection means 15, and a second database D2 (database). The model learning device 1A according to the present example embodiment is connected to the first database D1. The first database D1 may be a configuration of the model learning device 1A. Conversely, the second database D2 may not be the configuration of the model learning device 1A.

### First database D1

The first database D1 stores a plurality of drafts. The first database D1 accumulates the generated draft every time the second generative model (n-th generation) generates the draft.

### Second acquisition means 13

The second acquisition means 13 acquires a first generative model (n-th generation). The second acquisition means 13 acquires a plurality of drafts from the first database D1.

### Evaluation means 14

The evaluation means 14 evaluates the draft output by the second generative model (n-th generation). As described above, the second acquisition means 13 acquires the plurality of drafts from the first database D1.

Therefore, the evaluation means 14 according to the present example embodiment evaluates each of the plurality of drafts. Specifically, the evaluation means 14 includes a model construction means 141 and a score calculation means 142.

The model construction means 141 constructs the first generative model ((n+1)-th generation) from the first generative model (n-th generation) by the method indicated by the draft acquired by the second acquisition means. As described above, the second acquisition means 13 acquires the plurality of drafts from the first database D1. Therefore, the model construction means 141 constructs, from the first generative model (n-th generation), a plurality of first generative models ((n+1)-th generation) having different draft output algorithms by the methods indicated by the plurality of drafts.

The score calculation means 142 calculates a score based on the information output by the created first generative model ((n+1)-th generation). “Score” is the evaluation result of the draft. The score calculation means 142 calculates a higher score as the performance of the first generative model ((n+1)-th generation) is higher. That is, the “score” represents the level of the improvement effect of the first generative model (n-th generation) by the draft. The score calculation means 142 calculates scores of a plurality of drafts used for generating a plurality of first generative models ((n+1)-th generation).

### Second database D2

The second database D2 stores a plurality of first generative models ((n+1)-th generation) generated by the model construction means 141 and a draft used for generating each of the first generative models ((n+1)-th generation). Every time the evaluation means 14 generates the first generative model ((n+1)-th generation), the second database D2 accumulates the generated first generative model ((n+1)-th generation) and the draft. The second database D2 stores a plurality of evaluation results. The second database D2 accumulates the evaluation result in association with the relevant draft each time the evaluation means 14 evaluates the draft.

The second database D2 attaches a first label (label) indicating a good draft to a draft used for generating a first generative model ((n+1)-th generation) whose score satisfies a first predetermined condition among a plurality of drafts generated by a second generative model (n-th generation). The “first label” is an evaluation result of the draft as well as the score. The “first predetermined condition” includes, for example, that the rank of the score falls in the certain % from the top of the total, that the score is equal to or more than certain value, and the like. The second database D2 attaches a second label indicating a bad draft to a draft used for generating a first generative model ((n+1)-th generation) whose score satisfies a second predetermined condition among a plurality of drafts generated by a second generative model (n-th generation). The “second label” is an evaluation result of the draft similarly to the first label. The “second predetermined condition” includes, for example, that the rank of the score falls in the certain % from the bottom of the total, that the score is equal to or less than certain value, and the like.

### Selection means 15

The selection means 15 selects the first generative model ((n+1)-th generation) having the highest score from among the plurality of first generative models ((n+1)-th generation) generated by the evaluation means 14. As described above, the model learning device 1A according to the present example embodiment includes the second database D2. Therefore, the selection means 15 according to the present example embodiment selects the first generative model ((n+1)-th generation) having the highest score from among the plurality of first generative models ((n+1)-th generation) accumulated in the second database D2. The selected first generative model ((n+1)-th generation) is the first generative model most improved from the first generative model (n-th generation).

### First acquisition means 11A

The first acquisition means 11A acquires the second generative model (n-th generation) and the evaluation result, similarly to the acquisition means 11 according to the first illustrative example embodiment.

### Learning processing means 12A

Similarly to the learning processing means 12 according to the first illustrative example embodiment, when the second generative model (n-th generation) and the evaluation result are input, the learning processing means 12A generates the second generative model ((n+1)-th generation) by post-learning the second generative model (n-th generation) based on the evaluation result (first label and second label attached to each draft). The learning processing means 12A according to the present example embodiment causes the second generative model (n-th generation) to post-learn the relationship between the draft and the score by using a method of Direct Preference Optimization (DPO). That is, the learning processing means 12A causes the second generative model (n-th generation) to perform post-learning so as to generate a large number of drafts having contents closer to the draft to which the first label is attached than the draft to which the second label is attached. The method by which the learning processing means 12A causes the second generative model (n-th generation) to post-learn may be KTO (Kahneman-Tversky Optimization), SFT (Supervised Fine Tuning), PPO (Proximal Policy Optimization), or the like.

### Model learning device 1A and others

Although the first generative model M1A and the second generative model M2A have been described as different generative models, the first generative model M1A may be the second generative model M2A. In this case, the “information” generated by the first generative model is a draft.

### Effects of model learning device 1A

According to the model learning device 1A described above, effects similar to those of the model learning device 1 according to the first illustrative example embodiment can be obtained. That is, according to the model learning device 1A, it is possible to more efficiently improve the performance of the first generative model M1A. The model learning device 1A described above further includes the evaluation means 14 for evaluating the draft output by the second generative model (n-th generation), and the evaluation means 14 includes the model construction means 141 and the score calculation means 142. The model learning device 1A employs a configuration including the selection means 15 for selecting the first generative model ((n+1)-th generation) having the highest score from among the plurality of first generative models ((n+1)-th generation). Therefore, according to the model learning device 1A, it is also possible to efficiently improve the performance of the first generative model (n-th generation). The model learning device 1A employs a configuration in which the second database D2 attaches a good draft label to a draft whose score satisfies a predetermined condition among a plurality of drafts. In the model learning device 1A, a configuration is adopted in which the learning processing means 12A causes the second generative model (n-th generation) to post-learn the relationship between the draft and the score by using a preference optimization method. Therefore, according to the model learning device 1A, it is also possible to obtain an effect that the second generative model ((n+1)-th generation) can efficiently generate a draft that can obtain a high score.

### Flow of model learning method S1A

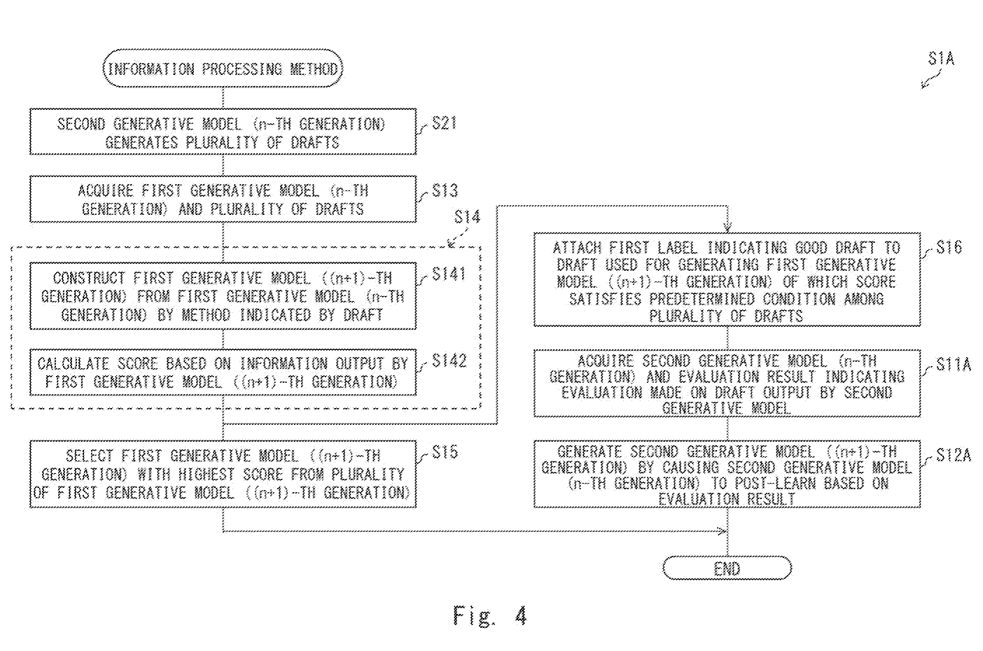

Next, a flow of the model learning method S1A will be described with reference to FIG. 4. FIG. 4 is a flowchart illustrating a flow of the model learning method S1A. As illustrated in FIG. 4, the model learning method S1A according to the present example embodiment includes a first acquisition step S11A, a learning processing step S12A (learning processing step), a second acquisition step S13, an evaluation step S14, a selection step S15, a classification step S16, and a draft generation step S21.

### Draft generation step S21

In the first draft generation step S21, the second generative model (n-th generation) generates a plurality of drafts. The plurality of generated drafts may be temporarily stored in a database, or may be directly used for evaluation in evaluation step S14 described later.

### Second acquisition step S13

In the second acquisition step S13, the computer acquires the first generative model (n-th generation). In the second acquisition step S13, a plurality of drafts generated in the draft generation step S21 are acquired. The computer that acquires the first generative model (n-th generation) and the draft may be the model learning device 1A or another device.

### Evaluation step S14

After the second generative model (n-th generation) generates the draft, the process proceeds to the evaluation step S14. In evaluation step S14, the computer evaluates the draft output by the second generative model (n-th generation). Specifically, the evaluation step S14 includes a model construction step S141 and a score calculation step S142.

In the first model construction step S141, the computer constructs the first generative model ((n+1)-th generation) by the method indicated by the draft. As described above, in the second acquisition step S13, a plurality of drafts is acquired. Therefore, in the model construction step S141, the computer generates a plurality of first generative models ((n+1)-th generation) having different draft output algorithms from the first generative models (n-th generation) by the methods indicated by the plurality of drafts. The computer that constructs the first generative model ((n+1)-th generation) may be the model learning device 1A or another device. The generated first generative model ((n+1)-th generation) may be stored in the database.

After the first generative model ((n+1)-th generation) is generated, the process proceeds to score calculation step S142. In the score calculation step S142, the computer calculates the score based on the information output by the created first generative model ((n+1)-th generation). In the score calculation step S142, the computer calculates the scores of the plurality of drafts used for generating the plurality of first generative models ((n+1)-th generation). The computer that calculates the score may be the model learning device 1A or another device. The calculated score may be stored in a database.

### Selection step S15

After the score is calculated, the process proceeds to selection step S15. In the selection step S15, the first generative model ((n+1)-th generation) having the highest score is selected from the plurality of first generative models ((n+1)-th generation) generated in the evaluation step S14. The computer that selects the first generative model ((n+1)-th generation) may be the model learning device 1A or another device.

### Classification step S16

After the score is calculated, classification step S16 is also performed. In the classification step S16, the computer attaches a first label (label) indicating that the draft is a good draft to the draft used for generating the first generative model ((n+1)-th generation) whose score satisfies the first predetermined condition among the plurality of drafts generated by the second generative model (n-th generation). In the classification step S16, the computer attaches the second label indicating that the draft is a bad draft to the draft used for generating the first generative model ((n+1)-th generation) whose score satisfies the second predetermined condition among the plurality of drafts generated by the second generative model (n-th generation). The computer that attaches the labels may be the model learning device 1A or another device.

### First acquisition step S11A

After the device evaluates the draft, the process proceeds to a first acquisition step S11A. In the first acquisition step S11A, similarly to the acquisition step S11 according to the first illustrative example embodiment, the computer acquires the second generative model (n-th generation) and the evaluation result. The computer that acquires the second generative model (n-th generation) and the evaluation result may be the model learning device 1A or another device.

### Learning processing step S12A

After the device acquires the second generative model (n-th generation) and the evaluation result, the process proceeds to learning processing step S12. In the learning processing step S12A, similarly to the learning processing step S12 according to the first illustrative example embodiment, when the second generative model (n-th generation) and the evaluation result are input, the computer generates the second generative model ((n+1)-th generation) by post-learning the second generative model (n-th generation) based on the evaluation result. The computer that generates the second generative model ((n+1)-th generation) may be the model learning device 1A or another device.

### Model learning method S1A and others

Although the first generative model M1A and the second generative model M2A have been described as different generative models, the first generative model M1A may be the second generative model M2A.

### Effects of model learning method S1A

According to the model learning method S1A described above, it is possible to obtain an effect similar to that of the model learning method S1 according to the first illustrative example embodiment. That is, according to the model learning method S1A, it is possible to more efficiently improve the performance of the first generative modelM1A. The model learning method S1A described above further includes the evaluation step S14 of evaluating the draft output by the second generative model (n-th generation), and the evaluation step S14 includes the model construction step S141 and the score calculation step S142. The model learning device 1A adopts a configuration including a selection step S15 of selecting a first generative model ((n+1)-th generation) having the highest score from among a plurality of first generative models ((n+1)-th generation). Therefore, according to the model learning method S1A, it is also possible to efficiently improve the performance of the first generative model (n-th generation). The model learning method S1A employs a configuration in which the computer attaches a good draft label to a draft whose score satisfies a predetermined condition among a plurality of drafts. Furthermore, in the model learning method S1A, a configuration is adopted in which the computer causes the second generative model (n-th generation) to post-learn the relationship between the draft and the score by using the preference optimization method in the learning processing step S12A. Therefore, according to the model learning method S1A, it is also possible to obtain an effect that the second generative model ((n+1)-th generation) can efficiently generate a draft that can obtain a high score.

### THIRD ILLUSTRATIVE EXAMPLE EMBODIMENT

A third illustrative example embodiment that is an example of an example embodiment of the present invention will be described in detail with reference to the drawings. Components having the same functions as the components described in the above-described illustrative example embodiment will be denoted by the same reference numerals, and the description thereof will be appropriately omitted. An application scope of each technical means adopted in the present illustrative example embodiment is not limited to the present illustrative example embodiment. That is, each technical means adopted in the present illustrative example embodiment can also be adopted in other illustrative example embodiments included in the present disclosure as long as no particular technical problem occurs. Each technical means illustrated in each of the drawings referred to for describing the present illustrative example embodiment can be adopted in other illustrative example embodiments included in the present disclosure as long as no particular technical problem occurs.

### Configuration of model learning device 1B

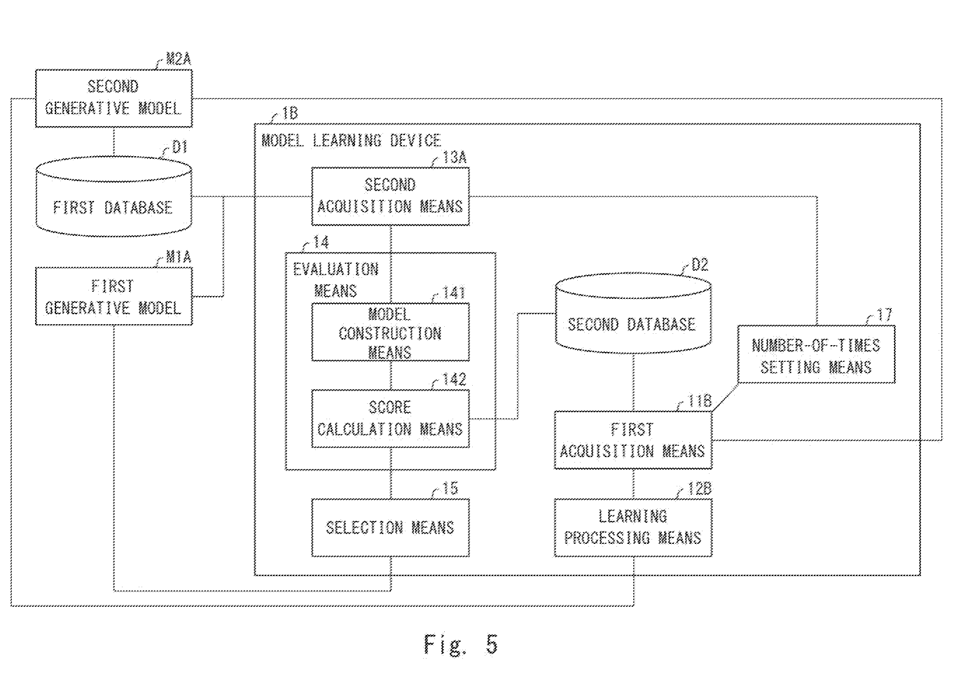

Next, a configuration of the model learning device 1B will be described with reference to FIG. 5. FIG. 5 is a block diagram illustrating a configuration of the model learning device 1B. As illustrated in FIG. 5, the model learning device 1B according to the present example embodiment includes an evaluation means 14, a selection means 15, and a second database D2 similar to those of the model learning device 1 according to the second illustrative example embodiment. The model learning device 1B according to the present example embodiment includes a first acquisition means 11B (acquisition means), a learning processing means 12B, a second acquisition means 13A, and a number-of-times setting means 17. The model learning device 1B according to the present example embodiment is connected to the first database D1 similarly to the model learning device 1 according to the second illustrative example embodiment.

### Number-of-times setting means 17

The number-of-times setting means 17 sets the maximum number of iterations N based on an operation performed by the user. The maximum number of iterations N is the maximum number of times the model learning device 1 generates a new second generative model M2A.

### Second acquisition means 13A

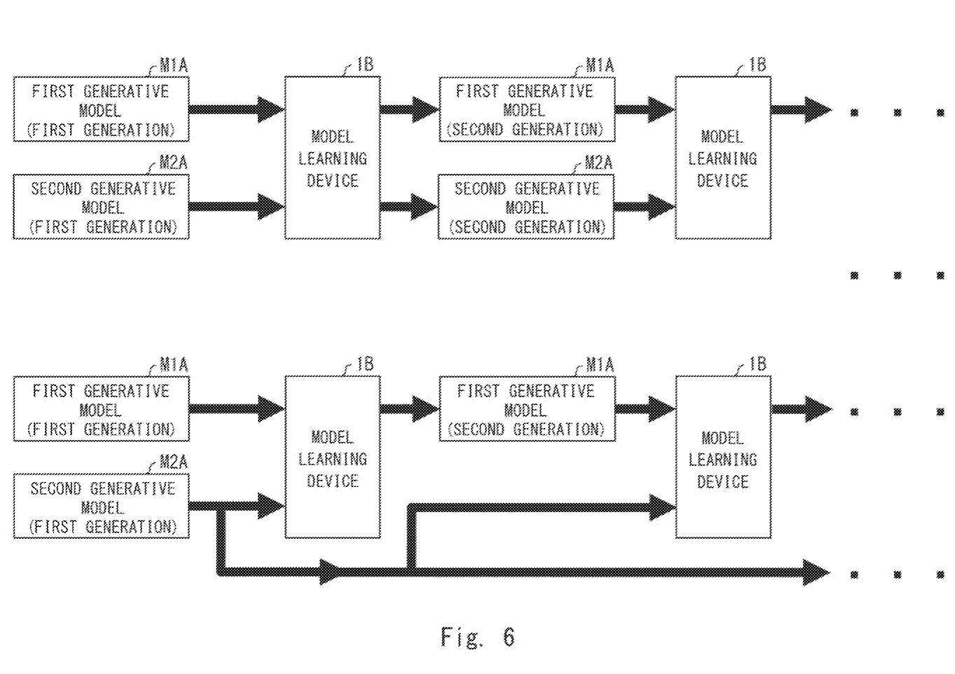

The second acquisition means 13A acquires the first generative model M1A in a case where the number of times the model learning device 1 has generated the new first generative model M1A (the generation number n of the first generative model (n-th generation) most recently selected by the selection means 15) is less than the maximum number of iterations N. The first generative model M1A acquired here may be the latest one (one most recently selected by the selection means 15) as illustrated in the upper part of FIG. 6, or may be the first one (one of the first generation) as illustrated in the lower part of FIG. 6. The second acquisition means 13A acquires a new draft output by the latest second generative model M2A generated by the learning processing means 12B.

### Evaluation means 14 and selection means 15

The evaluation means 14 and the selection means 15 repeat the operations described in the second illustrative example embodiment with respect to the first generative model M1A acquired by the second acquisition means 13A and the new draft output by the latest second generative model M2A.

### First acquisition means 11B

In a case where the number of times the model learning device 1 has generated a new second generative model M2A (the generation number n of the second generative model (n-th generation) most recently generated by the learning processing means 12B) is less than the maximum number of iterations N, the first acquisition means 11B acquires an evaluation result for the new second generative model M2A most recently generated and a new draft output by the new second generative model M2A.

### Learning processing means 12B

The learning processing means 12B repeats the operation described in the second illustrative example embodiment with respect to the second generative model M2A most recently generated acquired by the first acquisition means 11B, and the evaluation result for the new draft output by the latest second generative model M2A. The learning processing means 12B according to the present example embodiment generates the new second generative model M2A by changing a parameter that affects generation of a draft, the parameter being included in the second generative model M2A, when the second generative model M2A is caused to post-learn. The parameter that affects the generation of the draft includes, for example, a temperature parameter. The learning processing means 12B reduces (or increases) the parameter that affects the generation of the draft every time the second generative model M2A is subjected to post-learning based on the numerical value of the parameter of the current second generative model M2A and the hyperparameter that defines the change width.

### Effects of model learning device 1B

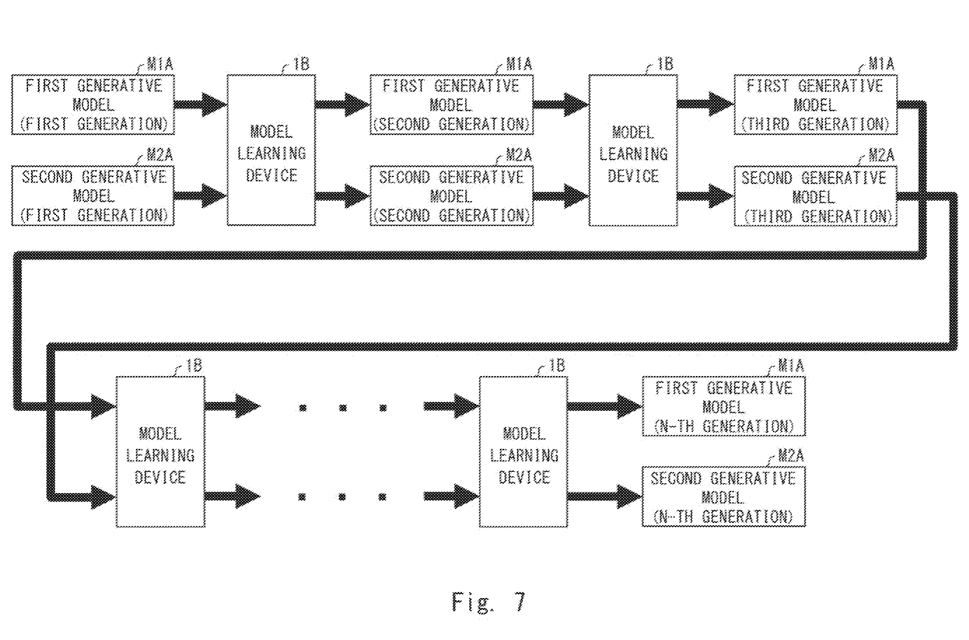

According to the model learning device 1B described above, effects similar to those of the model learning device 1 according to the first illustrative example embodiment can be obtained. That is, according to the model learning device 1B, it is possible to more efficiently improve the performance of the first generative model M1A. In the model learning device 1B described above, in a case where the number of times the model learning device 1 has generated the new second generative model M2A is less than the maximum number of iterations N, the first acquisition means 11B acquires the new second generative model M2A most recently generated and the evaluation result for the new draft output by the new second generative model M2A. As a result, the learning processing means 12B repeats the operation described in the second illustrative example embodiment with respect to the second generative model M2A most recently generated and the evaluation result for the new draft output by the latest second generative model M2A. Therefore, according to the model learning device 1B, as illustrated in FIG. 7, at least the performance of the second generative model M2A can be continuously improved.

### Flow of model learning method S1B

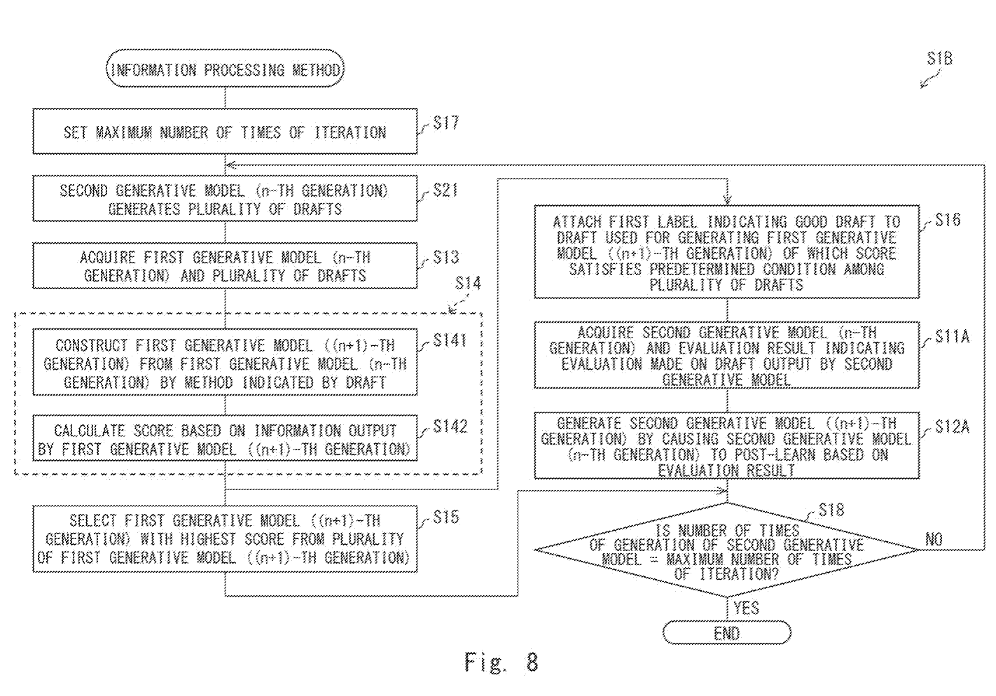

Next, a flow of the model learning method S1B will be described with reference to FIG. 8. FIG. 8 is a flowchart illustrating a flow of the model learning method S1B. As illustrated in FIG. 8, the model learning method S1B according to the present example embodiment includes a number-of-times setting step S17 and an end determination step S18 in addition to the first acquisition step S11A, the learning processing step S12A, the second acquisition step S13, the evaluation step S14, the selection step S15, the classification step S16, and the draft generation step S21 similar to the model learning method S1 according to the first illustrative example embodiment.

### Number-of-times setting step S17

In the first number-of-times setting step S17, the computer sets the maximum number of iterations N based on the operation performed by the user. The computer that sets the maximum number of iterations N may be the model learning device 1A or another device.

### End determination step S18

After the computer selects the first generative model ((n+1)-th generation) having the highest score and generates the second generative model ((n+1)-th generation), the process proceeds to the end determination step S18. In the end determination step S18, the computer determines whether the number of times of generation of the second generative model M2A has reached the maximum number of iterations. The computer that makes the determination may be the model learning device 1A or another device. Here, in a case where the computer determines that the number of times of generation of the second generative model M2A has reached the maximum number of iterations (step S18: YES), the model learning method S1B ends.

On the other hand, in the end determination step S18, in a case where the computer determines that the number of times of generation of the second generative model M2A has not reached the maximum number of iterations (step S18: NO), the processing proceeds to the draft generation step S21 again, and the subsequent processing is repeated.

### Effects of model learning device 1B

According to the model learning method S1B described above, effects similar to those of the model learning method S1 according to the first illustrative example embodiment can be obtained. That is, according to the model learning method S1B, it is possible to more efficiently improve the performance of the first generative model M1A. In the model learning method S described above, in a case where the number of times the computer has generated the new second generative model M2A is less than the maximum number of iterations N, in the first acquisition step S11B, a configuration is adopted in which the new second generative model M2A most recently generated and the evaluation result for the new draft output by the new second generative model M2A are acquired. As a result, in the learning processing step S12A, the computer repeats the operation described in the second illustrative example embodiment with respect to the second generative model M2A most recently generated and the evaluation result for the new draft output by the latest second generative model M2A. Therefore, according to the model learning method S1B, at least the performance of the second generative model M2A can be continuously improved.

### Example of implementation by software

Some or all of the functions of the model learning devices 1, 1A, and 1B (hereinafter also referred to as “each of the above devices”) may be implemented by hardware such as an integrated circuit (IC chip) or may be implemented by software.

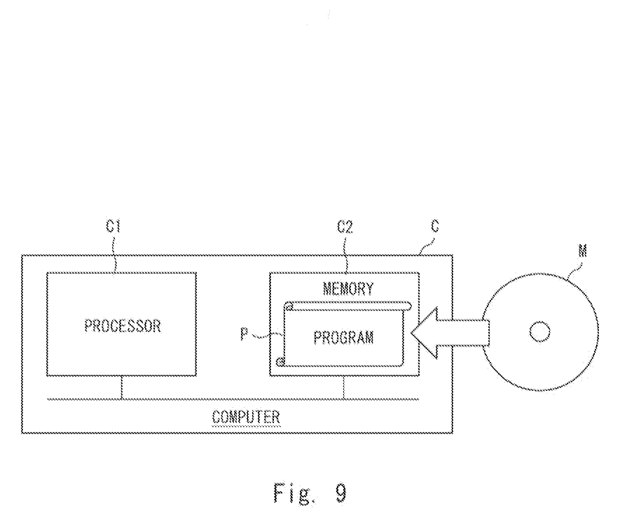

In the latter case, each of the above devices is implemented by, for example, a computer that executes a command of a program which is software for implementing each function. FIG. 9 illustrates an example of such a computer (hereinafter, referred to as a computer C). FIG. 9 is a block diagram illustrating a hardware configuration of a computer C functioning as each of the above devices.

The computer C includes at least one processor C1 and at least one memory C2. A model learning program P causing the computer C to operate as each of the above means is recorded in the memory C2. In the computer C, the processor C1 reads the program P from the memory C2 and executes the model learning program P to implement each function of each of the above means.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the model learning program P at the time of execution and temporarily storing various types of data. The computer C may further include a communication interface for transmitting and receiving data to and from other devices. The computer C may further include an input/output interface for connecting input/output devices such as a keyboard, a mouse, a display, and a printer.

The model learning program P can be recorded in a non-transitory tangible recording medium M readable by the computer C. As such a recording medium M, for example, a tape, a disk, a card, a semiconductor memory, a programmable logic circuit, or the like can be used. The computer C can acquire the model learning program P via such a recording medium M. The model learning program P can be transmitted via a transmission medium. As such a transmission medium, for example, a communication network, a broadcast wave, or the like can be used. The computer C can also acquire the model learning program P via such a transmission medium.

### Supplementary Information 1

The present disclosure includes techniques described in the following supplementary notes. However, the present invention is not limited to the techniques described in the following supplementary notes, and various modifications can be made within the scope described in the claims.

### Supplementary Note 1

A model learning device including an acquisition means for acquiring a second generative model constructed to output a draft of a method for constructing a first generative model for generating information, and an evaluation result indicating evaluation made on the draft output by the second generative model, and a learning processing means for, when the second generative model and the evaluation result are input, generating a new second generative model in which a draft output algorithm is changed, by causing the second generative model to post-learn based on the evaluation result.

### Supplementary Note 2

The model learning device according to Supplementary Note 1, further including an evaluation means for evaluating the draft output by the second generative model.

### Supplementary Note 3

The model learning device according to Supplementary Note 2, in which the evaluation means includes a model construction means for constructing a new first generative model from the first generative model, by a method indicated by the draft, and a score calculation means for calculating a score representing the size of an improvement effect by the draft based on the information output by the new first generative model.

### Supplementary Note 4

The model learning device according to Supplementary Note 3, further including a database that accumulates a plurality of the drafts generated by the second generative model, in which the database attaches a good draft label to the draft in which the score satisfies a predetermined condition among the plurality of accumulated drafts.

### Supplementary Note 5

The model learning device according to Supplementary Note 4, further including a selection means for selecting the new first generative model having the highest score from among the plurality of new first generative models.

### Supplementary Note 6

The model learning device according to Supplementary Note 4, in which the learning processing means causes the second generative model to post-learn a relationship between the draft and the score by using a preference optimization method.

### Supplementary Note 7

The model learning device according to any one of Supplementary Notes 1 to 6, in which the method for constructing the first generative model indicated by the draft is model merging.

### Supplementary Note 8

The model learning device according to any one of Supplementary Notes 1 to 7, in which the first generative model includes one trained model, a plurality of trained models of the same type, or a multimodal model in which different types of trained models are combined.

### Supplementary Note 9

The model learning device according to any one of Supplementary Notes 1 to 8, in which the acquisition means acquires the new second generative model and an evaluation result of a new draft output by the new second generative model, and when the new second generative model and the evaluation result are input, the learning processing means causes the new second generative model to post-learn based on the evaluation result, to generate a further new second generative model in which a draft output algorithm is changed.

### Supplementary Note 10

The model learning device according to Supplementary Note 9, further including an evaluation means for evaluating the new draft output by the new second generative model, in which the evaluation means constructs the first generative model by a method indicated by the new draft.

### Supplementary Note 11

The model learning device according to Supplementary Note 9 or 10, in which the learning processing means generates the new second generative model by changing a parameter that affects generation of a draft, the parameter being included in the second generative model, when the second generative model is caused to post-learn.

### Supplementary Note 12

The model learning device according to any one of Supplementary Notes 1 to 10, in which the first generative model is the second generative model.

### Supplementary Note 13

A model learning program that causes a computer to execute acquisition processing of acquiring a second generative model constructed to output a draft of a method for constructing a first generative model for generating information, and an evaluation result indicating evaluation made on the draft output by the second generative model, and learning processing of causing, when the second generative model and the evaluation result are input, the second generative model to post-learn based on the evaluation result and generating a new second generative model in which a draft output algorithm is improved.

### Supplementary Note 14

A model learning method including an acquisition step in which a computer acquires a second generative model constructed to output a draft of a method for constructing a first generative model for generating information, and an evaluation result indicating evaluation made on the draft output by the second generative model, and a learning processing step in which the computer causes, when the second generative model and the evaluation result are input, the second generative model to post-learn based on the evaluation result and to generate a new second generative model in which a draft output algorithm is improved.

### Supplementary Note 15

The model learning method according to Supplementary Note 14, further including an evaluation step in which a computer evaluates the draft output by the second generative model.

### Supplementary Note 16

The model learning method according to Supplementary Note 15, in which the evaluation step includes a model construction step in which the computer constructs a new first generative model from the first generative model, by a method indicated by the draft, and a score calculation step in which the computer calculates a score representing the size of an improvement effect by the draft based on the information output by the new first generative model.

### Supplementary Note 17

The model learning method according to Supplementary Note 16, in which the database that accumulates a plurality of the drafts generated by the second generative model attaches a good draft label to the draft in which the score satisfies a predetermined condition among the plurality of accumulated drafts.

### Supplementary Note 18

The model learning method according to Supplementary Note 17, further including a selection step in which the computer selects the new first generative model having the highest score from among the plurality of new first generative models.

### Supplementary Note 19

The model learning method according to Supplementary Note 17, in which in the learning processing step the computer causes the second generative model to post-learn a relationship between the draft and the score by using a preference optimization method.

### Supplementary Note 20

The model learning method according to any one of Supplementary Notes 14 to 19, in which the method for constructing the first generative model indicated by the draft is model merging.

### Supplementary Note 21

The model learning method according to any one of Supplementary Notes 14 to 20, in which the first generative model includes one trained model, a plurality of trained models of the same type, or a multimodal model in which different types of trained models are combined.

### Supplementary Note 22

The model learning method according to any one of Supplementary Notes 14 to 21, in which, in the acquisition step, the computer acquires the new second generative model and an evaluation result of a new draft output by the new second generative model, and in the learning processing step, when the new second generative model and the evaluation result are input, the computer causes the new second generative model to post-learn based on the evaluation result, to generate a further new second generative model in which a draft output algorithm is changed.

### Supplementary Note 23

The model learning method according to Supplementary Note 22, further including an evaluation step in which a computer evaluates the new draft output by the new second generative model, in which, in the evaluation step, the computer constructs the first generative model by a method indicated by the new draft.

### Supplementary Note 25

The model learning method according to Supplementary Note 22 or 23, in which in the learning processing step the computer generates the new second generative model by changing a parameter that affects generation of a draft, the parameter being included in the second generative model, when the second generative model is caused to post-learn.

### Supplementary Note 26

The model learning program according to Supplementary Note 13, causing the computer to further execute evaluation processing for evaluating the draft output by the second generative model.

### Supplementary Note 27

The model learning program according to Supplementary Note 26, in the evaluation processing, causing the computer to execute model construction for constructing a new first generative model from the first generative model, by a method indicated by the draft, and score calculation processing for calculating a score representing the size of an improvement effect by the draft based on the information output by the new first generative model.

### Supplementary Note 28

The model learning program according to Supplementary Note 27, causing the database that accumulates a plurality of the drafts generated by the second generative model to execute labeling processing for attaching a good draft label to the draft in which the score satisfies a predetermined condition among the plurality of accumulated drafts.

### Supplementary Note 29

The model learning program according to Supplementary Note 28, causing the computer to further execute selection process for selecting the new first generative model having the highest score from among the plurality of new first generative models.

### Supplementary Note 30

The model learning program according to Supplementary Note 28, in the learning processing, causing the second generative model to post-learn a relationship between the draft and the score by using a preference optimization method.

### Supplementary Note 31

The model learning program according to any one of Supplementary Notes 13 and 26 to 30, in the acquisition processing, acquiring the new second generative model and an evaluation result of a new draft output by the new second generative model, and in the learning processing, when the new second generative model and the evaluation result are input, causing the new second generative model to post-learn based on the evaluation result, to generate a further new second generative model in which a draft output algorithm is changed.

### Supplementary Note 32

The model learning program according to Supplementary Note 31, causing the computer to further execute evaluation processing for evaluating the draft output by the new second generative model, and in the evaluation processing, constructing the first generative model by a method indicated by the new draft.

### Supplementary Note 33

The model learning program according to Supplementary Note 31 or 32, in the learning processing, generating the new second generative model by changing a parameter that affects generation of a draft, the parameter being included in the second generative model, when the second generative model is caused to post-learn.

### Supplementary Information 2

The present disclosure includes techniques described in the following supplementary notes. However, the present invention is not limited to the techniques described in the following supplementary notes, and various modifications can be made within the scope described in the claims.

### Supplementary Note 1

A model learning device including at least one processor, the at least one processor executing acquisition processing for acquiring a second generative model constructed to output a draft of a method for constructing a first generative model for generating information, and an evaluation result indicating evaluation made on the draft output by the second generative model, and learning processing for, when the second generative model and the evaluation result are input, generating a new second generative model in which a draft output algorithm is changed, by causing the second generative model to post-learn based on the evaluation result.

### Supplementary Note 2

The model learning device according to Supplementary Note 1, in which the at least one processor further executes evaluation processing for evaluating the draft output by the second generative model.

### Supplementary Note 3

The model learning device according to Supplementary Note 2, in which the at least one processor, in the evaluation processing, executes model construction for constructing a new first generative model from the first generative model, by a method indicated by the draft, and score calculation processing for calculating a score representing the size of an improvement effect by the draft based on the information output by the new first generative model.

### Supplementary Note 4

The model learning device according to Supplementary Note 3, further including a database that accumulates a plurality of the drafts generated by the second generative model, in which the database attaches a good draft label to the draft in which the score satisfies a predetermined condition among the plurality of accumulated drafts.

### Supplementary Note 5

The model learning device according to Supplementary Note 4, in which the at least one processor further executes selection processing for selecting the new first generative model having the highest score from among the plurality of new first generative models.

### Supplementary Note 6

The model learning device according to Supplementary Note 4, in which the at least one processor, in the learning processing, causes the second generative model to post-learn a relationship between the draft and the score by using a preference optimization method.

### Supplementary Note 7

The model learning device according to any one of Supplementary Notes 1 to 6, in which the at least one processor, in the acquisition processing, acquires the new second generative model and an evaluation result of a new draft output by the new second generative model, and in the learning processing, when the new second generative model and the evaluation result are input, causes the new second generative model to post-learn based on the evaluation result, to generate a further new second generative model in which a draft output algorithm is changed.

### Supplementary Note 8

The model learning device according to Supplementary Note 7, in which the at least one processor further executes evaluation processing for evaluating the new draft output by the new second generative model, and in the evaluation processing, constructs the first generative model by a method indicated by the new draft.

### Supplementary Note 9

The model learning device according to Supplementary Note 7 or 8, in which the at least one processor, in the learning processing, generates the new second generative model by changing a parameter that affects generation of a draft, the parameter being included in the second generative model, when the second generative model is caused to post-learn.

### Supplementary Note 10

A non-transitory recording medium storing a model learning program that causes a computer to execute acquisition processing of acquiring a second generative model constructed to output a draft of a method for constructing a first generative model for generating information, and an evaluation result indicating evaluation made on the draft output by the second generative model, and learning processing of causing, when the second generative model and the evaluation result are input, the second generative model to post-learn based on the evaluation result and generating a new second generative model in which a draft output algorithm is improved.

1. A model learning device comprising:
at least one memory storing instructions; and
at least one processor configured to execute the instructions to;
acquire a second generative model constructed to output a draft of a method for constructing a first generative model for generating information, and an evaluation result indicating evaluation made on the draft output by the second generative model; and
learn, in the case where the second generative model and the evaluation result are input, generating a new second generative model in which a draft output algorithm is changed, by causing the second generative model to post-learn based on the evaluation result.

2. The model learning device according to claim 1, the at least one processor is further configured to execute the instructions to evaluate the draft output by the second generative model.

3. The model learning device according to claim 2, the at least one processor is further configured to execute the instructions to;
construct a new first generative model from the first generative model, by a method indicated by the draft; and
calculate a score representing the size of an improvement effect by the draft based on the information output by the new first generative model.

4. The model learning device according to claim 3, further comprising a database that accumulates a plurality of the drafts generated by the second generative model; and
the at least one processor is further configured to execute the instructions to attach a good draft label to the draft in which the score satisfies a predetermined condition among the plurality of accumulated drafts.

5. The model learning device according to claim 4, the at least one processor is further configured to execute the instructions to select the new first generative model having the highest score from among the plurality of new first generative models.

6. The model learning device according to claim 4, the at least one processor is further configured to execute the instructions to cause the second generative model to post-learn a relationship between the draft and the score by using a preference optimization method.

7. The model learning device according to claim 1, wherein the method for constructing the first generative model indicated by the draft is model merging.

8. The model learning device according to claim 1, wherein the first generative model includes one trained model, a plurality of trained models of the same type, or a multimodal model in which different types of trained models are combined.

9. The model learning device according to claim 1, the at least one processor is further configured to execute the instructions to;
acquire the new second generative model and an evaluation result of a new draft output by the new second generative model; and
in the case where the new second generative model and the evaluation result are input, cause the new second generative model to post-learn based on the evaluation result, to generate a further new second generative model in which a draft output algorithm is changed.

10. The model learning device according to claim 9, the at least one processor is further configured to execute the instructions to evaluate the new draft output by the new second generative model; and
construct the first generative model by a method indicated by the new draft.

11. The model learning device according to claim 9, the at least one processor is further configured to execute the instructions to generate the new second generative model by changing a parameter that affects generation of a draft, the parameter being included in the second generative model, in the case where the second generative model is caused to post-learn.

12. The model learning device according to claim 1, wherein the first generative model is the second generative model.

13. A non-transitory recording medium storing a model learning program that causes a computer to execute
acquisition processing of acquiring a second generative model constructed to output a draft of a method for constructing a first generative model for generating information, and an evaluation result indicating evaluation made on the draft output by the second generative model, and
learning processing of causing, in the case where the second generative model and the evaluation result are input, the second generative model to post-learn based on the evaluation result and generating a new second generative model in which a draft output algorithm is improved.

14. A model learning method comprising:
an acquisition step in which a computer acquires a second generative model constructed to output a draft of a method for constructing a first generative model for generating information, and an evaluation result indicating evaluation made on the draft output by the second generative model; and
a learning processing step in which the computer causes, in the case where the second generative model and the evaluation result are input, the second generative model to post-learn based on the evaluation result and generating a new second generative model in which a draft output algorithm is improved.
